(19) United States
(12) Patent Application Publication
(10) Pub. No.: US 2009/0171528 A1
(43) Pub. Date: Jul. 2, 2009

(54) APPARATUS AND PROCESS FOR RECORDING DATA ASSOCIATED WITH A VEHICLE

(75) Inventors: ITTAI GOLDE, Rishon LeZion (IL); JUDAH GAMLIEL HAHN, Ofra (IL); SASI LEVI, Kadima (IL); STEVEN THEODORE SPROUSE, San Jose, CA (US); SHAHAR BEN-DAVID, Kiryat Ono (IL)

Correspondence Address: TOLER LAW GROUP, 8500 BLUFFSTONE COVE, SUITE A201, AUSTIN, TX, 78759, US

(73) Assignee: SanDisk IL Ltd., Kfar Saba (IL)

(21) Appl. No.: 11/964,767

(22) Filed: Dec. 27, 2007

(51) Int. Cl. G06F 17/40; G01S 5/00; G01M 17/00

(52) U.S. Cl. 701/35; 342/357.07; 342/457; 701/1

(57) ABSTRACT

The present system for recording vehicle-related data does not involve an elaborate installation procedure and thus may be routinely transferred from one vehicle to the next. The system has a recording module and at least on sensor module. The recording module has a wireless receiver, a processor, a vehicle interface assembly, and a data processor interface. The vehicle interface assembly enables the recording module to detachably connect to the vehicle. The sensor modules have a sensor, a processing subsystem, and a wireless transmitter. The wireless transmitter of a sensor module communicates with the wireless receiver of the recording module. Also disclosed is a method of recording vehicle related data.

### BACKGROUND

Detailed records of vehicle-related data are useful for a variety of reasons. For example, such data may improve the diagnosis of a performance-type problem. Also, a personal automobile owner may want to track the use of the vehicle while provided temporarily to others.

Although a vehicle owner may permanently install multiple sensors and data recording equipment in a vehicle, care needs to be taken to prevent installation of components in areas likely to interfere with routine maintenance. This task is made difficult due to the compact design of many vehicles. Also, for households or fleets having multiple vehicles, the permanent nature of an individual installation of sensors and data recording equipment in one vehicle effectively requires that an additional system be installed for each of the vehicles.

Accordingly, it would be desirable to have an easy way to collect vehicle-related data without involving an elaborate installation procedure. It would be further desirable to have an easy way to connect the system of sensors and data recording equipment to allow the system to be routinely transferred from one vehicle to the next.

### SUMMARY

A design approach based in part on the foregoing observations is provided to enable the recording of vehicle-related data without involving an elaborate installation procedure. The design approach also provides an easy way to connect the system of sensors and data recording equipment to allow the system to be routinely transferred from one vehicle to the next. To implement this design approach, various embodiments are possible, including a system, a recording module, and a method for recording data associated with a vehicle.

In one embodiment, a system is provided for recording data associated with a vehicle. The system has a recording module and one or more sensor module. The recording module includes a wireless receiver, a processor operatively connected to the wireless receiver, a vehicle interface assembly operatively connected to the processor, and it may include also a data processor interface operatively connected to the processor. The vehicle interface assembly is configured for detachably connecting the recording module to a vehicle. The one or more sensor module each include a sensor, a processing subsystem operatively connected to the sensor, and a wireless transmitter operatively connected to the processing subsystem. The wireless transmitter and the wireless receiver are operative to communicate with each other.

The recording module of the system may further include a location determination subsystem operatively connected to the processor. The location determination subsystem of the recording module may be a GPS subsystem.

The recording module of the system may further include a storage device subsystem operatively connected to the processor. The storage device subsystem may further include a storage device interface and a non-volatile memory operable to connect to the processor via the storage device interface. The non-volatile memory may be a removable storage device. The removable storage device may be a memory card. The recording module may further include an encryption subsystem operable to encrypt data sent to the storage device subsystem.

The vehicle interface assembly of the system may be further configured for detachably connecting the recording module to a data bus or a port of a vehicle. The vehicle interface assembly of the recording module may include a physical interface and an onboard diagnostic processor. The physical interface of the vehicle interface assembly may be a controller area network (CAN) port.

The recording module of the system may be further configured to receive power through the vehicle interface assembly. The recording module may be further configured to receive power from a vehicle data bus.

In the system for recording data associated with a vehicle, the sensor in one or more of the sensor modules may be a location sensor, and the location sensor may be a GPS sensor. The sensor may be an environmental sensor. The sensor module may further include an independent power source or a connection to an external power source. The system may include at least two sensors located in two separate sensor modules.

In another embodiment, a recording module is provided for recording data associated with a vehicle. The recording module has a wireless receiver configured to receive sensor data from a sensor associated with a vehicle; a processor operatively connected to the wireless receiver; a vehicle interface assembly operatively connected to the processor; and it may include also a data processor interface operatively connected to the processor. The sensor data may be environmental sensor data. The vehicle interface assembly is configured for detachably connecting the recording module to the vehicle.

The recording module may further include a location determination subsystem operatively connected to the processor. The location determination subsystem may be a GPS subsystem.

The recording module may further include a storage device subsystem operatively connected to the processor. The storage device subsystem may further include a storage device interface and a non-volatile memory operable to connect to the processor via the storage device interface. The non-volatile memory may be a removable storage device. The removable storage device may be a memory card. The recording module may further include an encryption subsystem operable to encrypt data sent to the storage device subsystem.

The vehicle interface assembly may be further configured for detachably connecting the recording module to a data bus or a port of a vehicle. The vehicle interface assembly may include a physical interface and an onboard diagnostic processor. The physical interface of the vehicle interface assembly may be a controller area network (CAN) port.

The recording module may be further configured to receive power through the vehicle interface assembly. The recording module may be further configured to receive power from a vehicle data bus.

In yet another embodiment, a method is provided for recording data associated with a vehicle. The method includes: receiving, in a detachably-connected recording module, vehicle data through a vehicle data interface; receiving, via a wired or wireless connection, sensor data from a sensor associated with the vehicle; and recording the vehicle data and the sensor data in a storage device. The sensor data may be environmental data associated with the vehicle.

The method may include receiving power through the vehicle data interface. In such method, the vehicle data interface may convey the power as well as the vehicle and sensor data from a vehicle data bus.

The method may further include: operating a location determination subsystem to receive location data; and recording the location data in the storage device. In such method, the location data may be GPS data. The method may include: receiving power through the vehicle data interface; in such case, the power received through the vehicle data interface is used to operate the location determination subsystem and to record the location data. In the method, the location determination subsystem may be positioned within the vehicle. Alternatively, the location determination subsystem may be positioned at the vehicle exterior.

In the method, the storage device may be a non-volatile memory in the recording module. The method may include encrypting the vehicle data and the sensor data to be recorded in the storage device. The method may include transferring the vehicle data and the sensor data from the storage device to a data processor.

These and other embodiments, features, aspects and advantages thereof will become better understood from the description herein, appended claims, and accompanying drawings as hereafter described.

### BRIEF DESCRIPTION OF THE DRAWINGS

The accompanying drawings, which are incorporated in and constitute a part of this specification illustrate various aspects of the various embodiment and together with the description, serve to explain them in greater detail. Wherever convenient, the same reference numbers will be used throughout the drawings to refer to the same or like elements, wherein:

FIG. 1 illustrates a system for recording data associated with a vehicle;

FIG. 2 provides a schematic representation of a recording module of the system illustrated in FIG. 1;

FIG. 3 provides a schematic representation of a sensor module of the system illustrated in FIG. 1;

FIG. 4 provides a schematic representation of an alternate embodiment of the sensor module represented in FIG. 3; and

FIG. 5 presents a flow chart representing a method of recording data associated with vehicle.

### DETAILED DESCRIPTION

The claims below will be better understood by referring to the detailed description of the various embodiments. This description is not intended to limit the scope of claims but instead to explain the design principles and the various embodiments that implement them. Examples of the various embodiments include a system for recording data associated with a vehicle, a recording module, and method of recording the data.

The data to be recorded as referenced in following description generally falls into two categories: vehicle data and environmental data. Vehicle data include vehicle speed data, engine temperature data, oil pressure data, and can even include vehicle attitude data. Much of the data that appears on a vehicle dashboard is deemed “vehicle data.” Environmental data include ambient temperature data, wind velocity data, and humidity data. Other data referenced in the description below are location data, which relates directly to both the vehicle and to the environment.

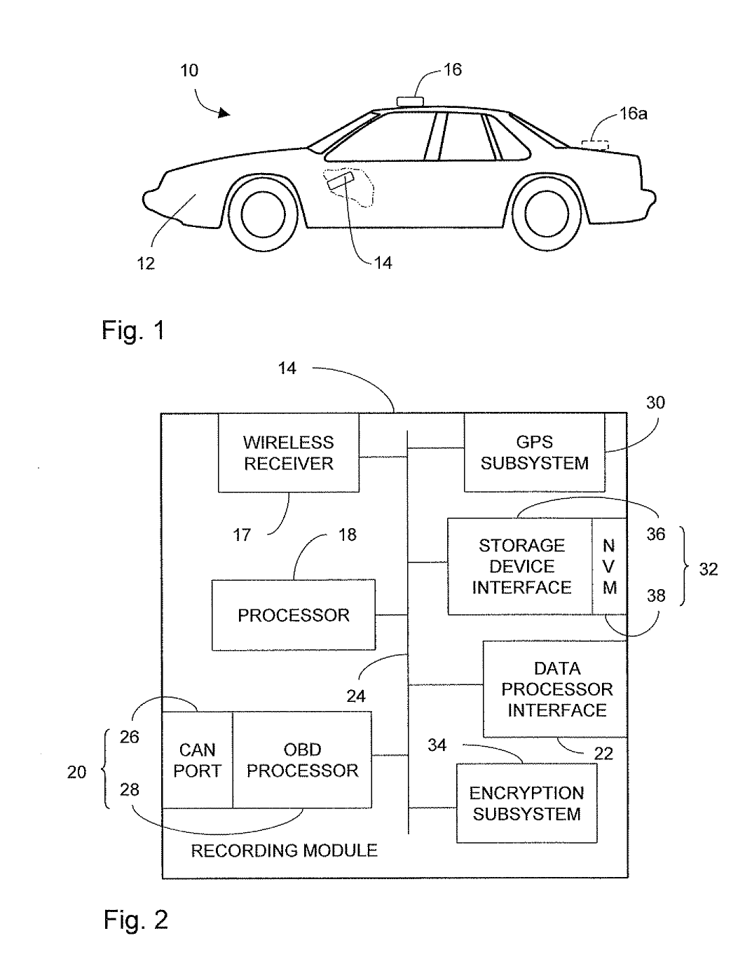

The embodiment illustrated in FIG. 1 is a system 10 for recording data associated with a vehicle 12. In the present disclosure, the term “vehicle” refers broadly to a variety of mechanisms for transport, such as but not limited to automobiles, trucks, motorcycles, and water crafts.

As shown in FIG. 1, the system 10 has a recording module 14 and a sensor module 16. As discussed below, alternate embodiments of the system 10 may include additional sensor modules, such as sensor module 16a. The recording module 14 in this embodiment is installed under the dashboard of the vehicle 12, and the sensor module 16 is installed on the roof of the vehicle 12, although other exterior locations on the vehicle 12 may be chosen for the site of the sensor module 16. There term “exterior” in this disclosure includes reference to locations slightly shielded from outer elements or slightly recessed within the body of the vehicle 12. For example, a temperature sensor located within the rear bumper of vehicle 12 is still regarded as positioned at the vehicle exterior.

FIG. 2 provides a schematic representation of the recording module 14, which includes a wireless receiver 17, a processor 18, a vehicle interface assembly 20, and a data processor interface 22. Each of the wireless receiver 17, the vehicle interface assembly 20, and the data processor interface 22 is connected to the processor 18 through a bus 24. In alternate embodiments, though, the first three elements may be connected directly to the processor 18 instead of multiplexing though the bus 24, or combinations of direct connections and shared bus connections may be implemented. Moreover, a bus such as bus 24 may interface all or only some of the aforementioned components so that, in the latter case, more than one bus may be required.

In this embodiment, the recording module 14 obtains power and vehicle data through the vehicle interface assembly 20. The vehicle data may include information that is shown on the dashboard, for example, vehicle speed, odometer reading, and possibly tire pressure.

The vehicle interface assembly 20 is configured for detachably connecting the recording module 14 to the vehicle 12. In this embodiment, the vehicle interface assembly 20 has a controller area network (CAN) port 26 as a physical interface and an onboard diagnostic processor 28. Although in this embodiment the vehicle interface assembly 20 enables the recording module 14 to detachably connect to the vehicle 12 through its CAN port, in other embodiments the recording module 14 may be connected to the vehicle data bus in other ways, such as by using vehicle-specific connectors.

In this embodiment, the recording module 14 receives power through the vehicle interface assembly 20. In alternate embodiments, though, the recording module 14 may be configured to receive power in other ways, such as directly from the vehicle battery or through the vehicle cigarette lighter.

The data processor interface 22 enables the recording module 14 to connect to an external data processor while receiving data or after it receives data. Such connection enables the data processor to store and/or to analyze the data. The data processor may be a personal computer, personal digital assistant (PDA), mobile telephone, dedicated data collection device, or like element that has an operating system. The data processor interface 22 can be a universal serial bus (USB), a multimedia card (MMC), a Bluetooth, a wireless fidelity (Wi-Fi), or a wireless USB (WUSB) interface.

Although not necessary in every embodiment, the recording module 14 of the present embodiment may also include a location determination subsystem 30, a storage device subsystem 32, and an encryption subsystem 34. Each of these elements is also connected to the processor 18 through the bus 24. In alternate embodiments, though, the three elements may be connected directly to the processor 18 instead of multiplexing though the bus 24, or combinations of direct connections and shared bus connections may be implemented. For example, the storage device subsystem 32 may be connected directly to encryption subsystem 34, which is connected directly to the bus 24.

In this embodiment, the location determination subsystem 30 is a global positioning satellite (GPS) subsystem. In alternate embodiments, the location determination subsystem may provide location data based on triangulating cellular telephone tower signals or on dead reckoning.

The storage device subsystem 32 of this embodiment includes a storage device interface 36 and a non-volatile memory 38, which connects to the processor 18 via the storage device interface 36. The non-volatile memory 38 may be a removable storage device, such as a memory card. For example, the non-volatile memory 38 may be flash memory, such as NAND flash memory in a Secure Digital/MultiMedia Card (SD/MMC), or micro SD card. In alternate embodiments that do not have storage device subsystems, the user may connect the recording module to the data processor during operation of the recording device, and the data processor will immediately receive the data as it arrives.

The encryption subsystem 34 may be activated to encrypt data sent to the storage device subsystem 32. By encrypting data, a user is able to guard against unauthorized access to personal information.

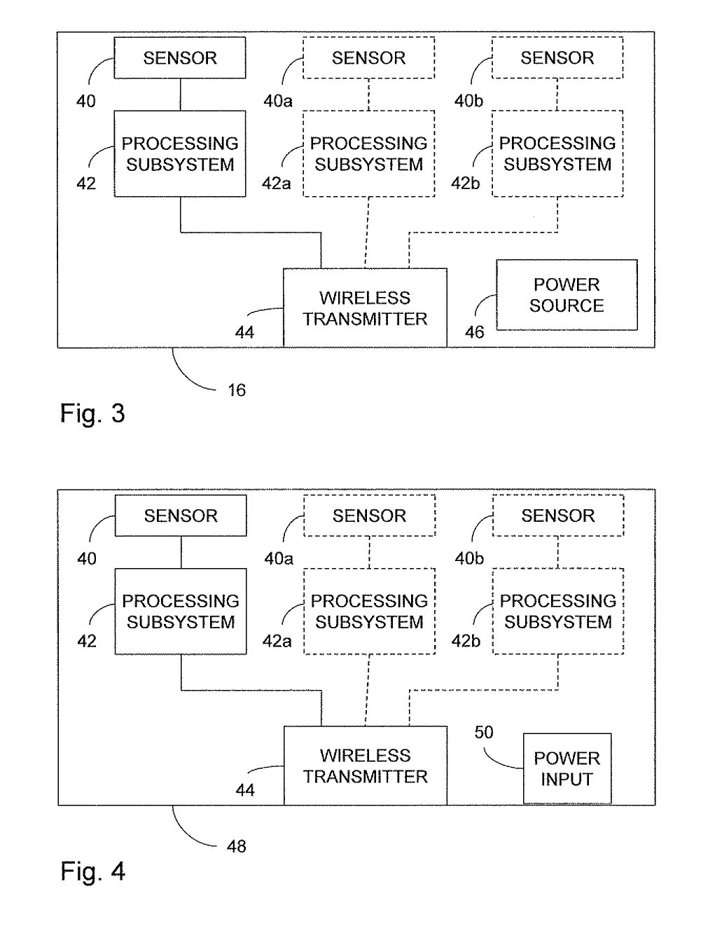

FIG. 3 provides a schematic representation of the sensor module 16 of FIG. 1. The sensor module 16 includes a sensor 40 operatively connected to a processing subsystem 42, which is also operatively connected to a wireless transmitter 44. When the system 10 operates, the wireless transmitter 44 and the wireless receiver 17 of the recording module 14 communicate with each other.

The sensor 40 may be an ambient temperature sensor, a wind velocity sensor, a barometer, an ambient light sensor, a camera, an audio sensor, or a gyroscope. That is, the sensor may provide vehicle data or environmental data. The sensor 40 might be a location sensor such as a GPS sensor. The sensor module 16 may be modified to include simultaneously more than one sensor, such as sensors 40a and 40b as represented in FIG. 3 by dashed lines. Each of sensors 40a and 40b has corresponding processing subsystems 42a and 42b, respectively, which are operatively connected between the corresponding sensor and the wireless transmitter 44.

The processing subsystem 42 (and processing subsystems 42a and 42b in alternate embodiments) converts the output the associated sensor into a format appropriate for the wireless transmitter 44. For example, if the sensor is a camera, the processing subsystem may need to pre-process and compress images. For other sensors, though, the processing subsystem may act more like a simple medium.

The sensor module 16 includes an independent power source 46, as represented in FIG. 3. The independent power source may be a battery or a solar panel. As an alternative, a sensor module 48 may be configured to have a power input, represented in FIG. 4 as connection 50, for connection to the vehicle's power system.

As noted above and illustrated in FIG. 1, the system 10 may be modified to include additional sensor modules. Accordingly, at least two individual sensors of such a system are located in two separate sensor modules. This system enables the placement of different types of sensors on different parts of the vehicle's exterior when a single location is not optimum for all sensors of the system. For example, a camera may be placed in front of the vehicle viewing forward, an ambient temperature gauge may be placed far from the vehicle engine, such as under the rear bumper, and a GPS sensor may be placed on top of the vehicle, where it can have a clear line of sight to GPS satellites.

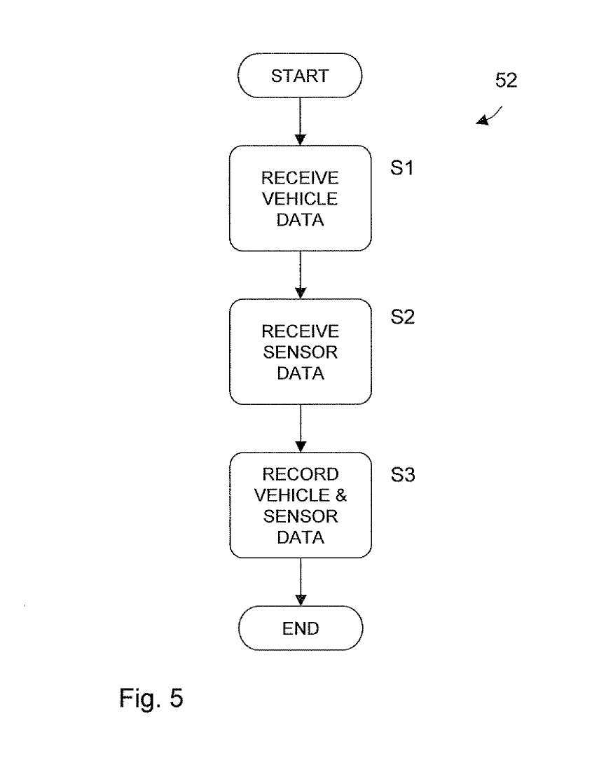

FIG. 5 presents a flow chart 52, which represents an embodiment of a method of recording data associated with vehicle. One step of the method is to receive, in a detachably-connected recording module, vehicle data through a vehicle data interface. [Step S1.] Another step is to receive, via a wired or wireless connection, sensor data from a sensor associated with the vehicle. [Step S2.] The sensor data may be environmental data associated with the vehicle. A third step is to record the vehicle data and the sensor data in a storage device. [Step S3.]

In an alternate embodiment, the method includes the step of receiving power through the vehicle data interface. In such method, the vehicle data interface may convey the power as well as the vehicle and sensor data from a vehicle data bus.

In another alternate embodiment, the method includes the steps of operating a location determination subsystem to receive location data and another step of recording the location data in the storage device. The location data received and recorded may be GPS data or alternatively data based on triangulating cellular telephone tower signals or on dead reckoning. In a variation of this embodiment, the method further includes the step of receiving power through the vehicle data interface; in which case the power received through the vehicle data interface is used to operate the location determination subsystem and to record the location data. In this embodiment, the location determination subsystem may be positioned within the vehicle or at the vehicle exterior.

With respect to the third step of the embodiment represented in FIG. 3, a non-volatile memory in the recording module may be implemented as the storage device. An embodiment may include the additional step of encrypting the vehicle data and the sensor data to be recorded in the storage device. Another step that can be added is transferring the vehicle data and the sensor data from the storage device to a data processor.

Having thus described the foregoing exemplary embodiments it will be apparent to those skilled in the art that various equivalents, alterations, modifications, and improvements thereof are possible without departing from the scope and spirit of the claims as hereafter recited. Accordingly, the claims are not limited to the foregoing discussion.

We claim:

1. A system for recording data associated with a vehicle, the system comprising:
a recording module including
a wireless receiver,
a processor operatively connected to the wireless receiver,
a vehicle interface assembly operatively connected to the processor, and
wherein the vehicle interface assembly is configured for detachably connecting the recording module to a vehicle; and
one or more sensor modules each including
a sensor,
a processing subsystem operatively connected to the sensor, and
a wireless transmitter operatively connected to the processing subsystem;
wherein the wireless transmitter and the wireless receiver are operative to communicate with each other.

2. The system of claim 1, wherein the recording module further includes a data processor interface operative to connect the recording module to an external data processor while receiving or after receiving data.

3. The system of claim 1, wherein the recording module further includes a location determination subsystem operatively connected to the processor.

4. The system of claim 3, wherein the location determination subsystem of the recording module is a GPS subsystem.

5. The system of claim 1, wherein the recording module further includes a storage device subsystem operatively connected to the processor.

6. The system of claim 5, wherein the storage device subsystem further includes a storage device interface and a non-volatile memory operable to connect to the processor via the storage device interface.

7. The system of claim 6, wherein the non-volatile memory is a removable storage device.

8. The system of claim 7, wherein the removable storage device is a memory card.

98. The system of claim 5, wherein the recording module further includes an encryption subsystem operable to encrypt data sent to the storage device subsystem.

10. The system of claim 1, wherein the vehicle interface assembly is further configured for detachably connecting the recording module to a data bus or a port of a vehicle.

11. The system of claim 1, wherein the vehicle interface assembly of the recording module includes a physical interface and an onboard diagnostic processor.

12. The system of claim 11, wherein the physical interface of the vehicle interface assembly is a controller area network (CAN) port.

13. The system of claim 1, wherein the recording module is further configured to receive power through the vehicle interface assembly.

14. The system of claim 1, wherein the recording module is further configured to receive power from a vehicle data bus.

15. The system of claim 1, wherein the sensor in one or more of the sensor modules is a location sensor.

16. The system of claim 15, wherein the location sensor is a GPS sensor.

17. The system of claim 1, wherein the sensor in one or more of the sensor modules is an environmental sensor.

18. The system of claim 1, wherein the sensor module further includes an independent power source or a connection to an external power source.

19. The system of claim 1, wherein at least two sensors are located in two separate sensor modules.

20. A recording module for recording data associated with a vehicle, the recording module comprising:
a wireless receiver configured to receive sensor data from a sensor associated with a vehicle;
a processor operatively connected to the wireless receiver;
a vehicle interface assembly operatively connected to the processor; and
wherein the vehicle interface assembly is configured for detachably connecting the recording module to the vehicle.

21. The recording module of claim 20, wherein the recording module further includes a data processor interface operative to connect the recording module to an external data processor while receiving or after receiving data.

22. The recording module of claim 20, wherein the recording module further includes a location determination subsystem operatively connected to the processor.

23. The recording module of claim 22, wherein the location determination subsystem is a GPS subsystem.

24. The recording module of claim 20, further comprising:
a storage device subsystem operatively connected to the processor.

25. The recording module of claim 24, wherein the storage device subsystem further includes a storage device interface and a non-volatile memory operable to connect to the processor via the storage device interface.

26. The recording module of claim 25, wherein the non-volatile memory is a removable storage device.

27. The recording module of claim 26, wherein the removable storage device is a memory card.

28. The recording module of claim 24 further comprising:
an encryption subsystem operable to encrypt data sent to the storage device subsystem.

29. The recording module of claim 20, wherein the vehicle interface assembly is further configured for detachably connecting the recording module to a data bus or a port of a vehicle.

30. The recording module of claim 20, wherein the vehicle interface assembly includes a physical interface and an onboard diagnostic processor.

31. The recording module of claim 30, wherein the physical interface of the vehicle interface assembly is a controller area network (CAN) port.

32. The recording module of claim 20, wherein the recording module is further configured to receive power through the vehicle interface assembly.

33. The recording module of claim 20, wherein the recording module is further configured to receive power from a vehicle data bus.

34. The recording module of claim 20, wherein the sensor data are environmental sensor data.

35. A method of recording data associated with a vehicle, the method comprising:
receiving, in a detachably-connected recording module, vehicle data through a vehicle data interface;
receiving, via a wired or wireless connection, sensor data from a sensor associated with the vehicle; and
recording the vehicle data and the sensor data in a storage device.

36. The method of claim 35 further comprising:
receiving power through the vehicle data interface.

37. The method of claim 36, wherein the vehicle data interface conveys the power as well as the vehicle and sensor data from a vehicle data bus.

38. The method of claim 35 further comprising:
operating a location determination subsystem to receive location data; and
recording the location data in the storage device.

39. The method of claim 38, wherein the location data are GPS data.

40. The method of claim 38 further comprising:
receiving power through the vehicle data interface;
wherein the power received through the vehicle data interface is used to operate the location determination subsystem and to record the location data.

41. The method of claim 38, wherein the location determination subsystem is positioned within the vehicle.

42. The method of claim 38, wherein the location determination subsystem is positioned at the vehicle exterior.

43. The method of claim 35, wherein the sensor data are environmental data associated with the vehicle.

44. The method of claim 35, wherein the storage device is a non-volatile memory in the recording module.

45. The method of claim 35 further comprising:
encrypting the vehicle data and the sensor data to be recorded in the storage device.

46. The method of claim 35 further comprising:
transferring the vehicle data and the sensor data from the storage device to a data processor.
